(19) United States
(12) Patent Application Publication
(10) Pub. No.: US 2013/0267215 A1
(43) Pub. Date: Oct. 10, 2013

(54) SYSTEM, METHOD, AND APPARATUS FOR PROVIDING A COMMUNICATION-BASED SERVICE USING AN INTELLIGENT INFERENCE ENGINE

(71) Applicant: SAMSUNG ELECTRONICS CO., LTD., Gyeonggi-do (KR)

(72) Inventors: Eunhee Rhim, Gyeonggi-do (KR); Suckho Seo, Gyeonggi-do (KR); Kisuh Ahn, Seoul (KR); Hyejung Yang, Gyeonggi-do (KR); Kyungsoo Lim, Gyeonggi-do (KR); Jinha Jun, Seoul (KR); Siejoon Cho, Seoul (KR)

(73) Assignee: Samsung Electronics Co., Ltd., Gyeonggi-do (KR)

(21) Appl. No.: 13/856,031

(22) Filed: Apr. 3, 2013

(30) Foreign Application Priority Data
Apr. 4, 2012 (KR) 10-2012-0035022

(51) Int. Cl. H04W 8/22

(52) U.S. Cl. CPC H04W 8/22
USPC 455/418

(57) ABSTRACT

A system, method and terminal are provided for performing a communication-based service using an intelligent inference engine. The system includes a user terminal including the intelligent inference engine that automatically performs at least one of information processing and output according to a use of a terminal function, and at least one connection terminal that performs at least one of a response to information provision related with the use of the terminal function of the user terminal and information transmission of the user terminal, and an output of received information.

### PRIORITY

This application claims priority under 35 U.S.C. §119(a) to Korean Patent Application Serial No. 10-2012-0035022, which was filed in the Korean Intellectual Property Office on Apr. 4, 2012, the entire disclosure of which is hereby incorporated by reference.

### BACKGROUND OF THE INVENTION

1. Field of the Invention

The present invention relates generally to a system, terminal, and method for supporting a communication-based service using an intelligent inference engine, and more particularly, to a system, terminal, and method for supporting a communication-based service using an intelligent inference engine which supports an appropriate response and service according to various situations and states of the terminal.

2. Description of the Related Art

One of the most commonly used functions of a mobile terminal is a communication function. However, the conventional communication function essentially requires user control and thus, when a user cannot control the mobile terminal since the user could not know a certain communication function provided by the mobile terminal, use of the communication function is difficult.

Further, in order to use a specific function in a conventional mobile terminal, a complicated procedure should be performed and controlled. For example, a user should perform a plurality of steps in order to search a location of a certain function on a menu.

Additionally, for conventional communication functions, there is a limit that unknown communication services cannot be provided since a user has not yet learned to use certain communication services, and thus, only the communication services known to a user may be provided. Hence, it is impossible to provide more convenient and timely services to user.

### SUMMARY OF THE INVENTION

Accordingly, the present invention is designed to address at least the problems and/or disadvantages described above and to provide at least the advantages described below.

An aspect of the present invention is to provide a system, method, and terminal that provide a communication-based service using an intelligent inference engine, which processes and operates the communication-based more intelligently.

Another aspect of the present invention is to provide a system, method, and terminal using an intelligent inference engine implements a service optimized for each user, and provides a service to user at an appropriate time, in an appropriate form.

In accordance with an aspect of the present invention, a system supporting a communication-based service using an intelligent inference engine is provided. The system includes a user terminal including the intelligent inference engine that automatically performs at least one of information processing and output according to a use of a terminal function, and at least one connection terminal that performs at least one of a response to information provision related with the use of the terminal function of the user terminal and information transmission of the user terminal, and an output of received information.

In accordance with another aspect of the present invention, a method is provided for supporting a communication-based service by a user terminal using an intelligent inference engine. The method includes activating a specific terminal function of the user terminal, automatically processing information generated according to the activation of the terminal function using the intelligent inference engine, and outputting information processed by the intelligent inference engine.

In accordance with another aspect of the present invention, a user terminal is provided that uses an intelligent inference engine. The user terminal includes a display that outputs a screen according to an activation of a terminal function; a communication unit that forms a communication channel with at least one connection terminal according to the activation of the terminal function; a memory that stores a Machine Intelligent Agent (MIA) module including the intelligent inference engine, a user database, and a recognition database for supporting a recognition function; an information collection unit that collects location information; and a controller that processes and transmits information for supporting the terminal function using the intelligent inference engine.

### BRIEF DESCRIPTION OF THE DRAWINGS

The above and other aspects, features, and advantages of certain embodiments of the present invention will be more apparent from the following detailed description in conjunction with the accompanying drawings, in which:

FIG. 1 illustrates a system that provides a communication-based service using an intelligent inference engine, according to an embodiment of the present invention;

FIG. 2 illustrates a user terminal according to an embodiment of the present invention;

FIG. 3 illustrates a controller of a user terminal according to an embodiment of the present invention;

FIG. 4 illustrates a machine intelligent agent (MIA) according to an embodiment of the present invention;

FIGS. 5 to 8 illustrate data transmission and processing during an intelligent negotiation service according to embodiments of the present invention;

FIG. 9 illustrates examples of screens displayed on a user terminal during an intelligent response service according to an embodiment of the present invention;

FIG. 10 is a signal flow diagram illustrating an intelligent response service according to an embodiment of the present invention;

FIG. 11 illustrates examples of screens displayed on a user terminal during an intelligent information service according to an embodiment of the present invention;

FIGS. 12 and 13 illustrate examples of screens displayed on a user terminal during an intelligent search service according to an embodiment of the present invention;

FIG. 14 illustrates examples of screens displayed on a user terminal during an intelligent recommendation service according to an embodiment of the present invention; and

FIG. 15 illustrates examples of screens displayed on a user terminal during an intelligent negotiation service according to an embodiment of the present invention.

### DETAILED DESCRIPTION OF EMBODIMENTS OF THE INVENTION

Various embodiments of the present invention are described in detail below with reference to the accompanying drawings. The same reference numbers are used throughout the drawings to refer to the same or like parts. Detailed descriptions of well-known functions and structures incorporated herein may be omitted to avoid obscuring the subject matter of the present invention.

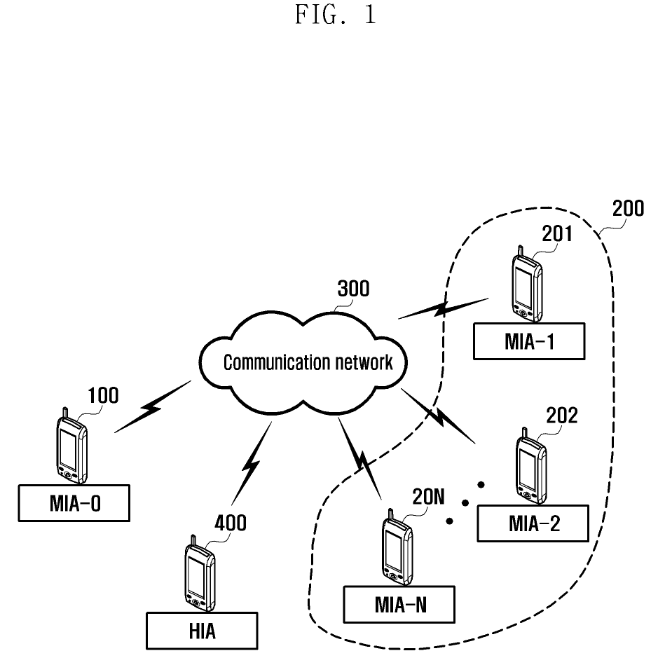

FIG. 1 illustrates a system that provides a communication-based service using an intelligent inference engine, according to an embodiment of the present invention.

Referring to FIG. 1, the system includes a user terminal 100, a communication service device 300, connection terminals 200, and a terminal 400, which transmits user information of the terminal 400 directly to the user terminal 100. The terminal 400 includes a Human Intelligent Agent (HIA) and communicates with the user terminal 100, which includes a Machine Intelligent Agent (MIA). The terminal 400 may also operate as one of the connection terminals 200.

The system forms a communication channel with at least one of the connection terminals 200, e.g., in a Peer to Peer (P2P) scheme, and supports transmission/reception and processing of various data for a communication-based service. In particular, the system supports at least one communication-based service, based on an intelligent inference engine. Examples of the communication-based service include an intelligent response service, an intelligent information processing service, an intelligent search service, an intelligent recommendation service, and an intelligent negotiation service.

Herein, the intelligent response service supports transmission of specific information, which fits a situation of the user terminal 100, to one of the connection terminals 200, when on of the connection terminals 200 requests a call connection service to the user terminal 100. For example, the intelligent response service provides various alarm information to the one of the connection terminals 200 according to the situation, location, etc., of the user terminal 100.

In the intelligent information processing service, when one of the connection terminal 200 provides specific information to the user terminal 100, the user terminal 100 parses the specific information, checks attributes of the specific information, and processes the specific information corresponding to the information attributes. For example, the intelligent information processing service allows an application for performing the function of the terminal to be automatically or optionally processed by foreground or background processing, or add a procedure for user confirmation. Further, the intelligent information processing service allows a user to check a result of the information processing.

The intelligent search service collects location information of the user terminal 100, automatically or in response to an occurrence of an event, and collects and provides circumference information such as a location information of the user terminal 100, current time information, scheduled information, receipt message received from the connection terminal, etc., based on the collected location information. The circumference information may be obtained from information stored in the user terminal 100 or from the connection terminal 200, which provides the information. Alternatively, an automatic inference function of an intelligent inference engine may search the connection terminal 200. Further, the intelligent search service may provide the searched circumference information to be different or provide more detailed circumference information to be searched depending on whether the user terminal 100 is moved.

The intelligent recommendation service parses a specific search word in information exchanged between the user terminal 100 and one of the connection terminals 200, and searches for and recommends searched information corresponding to the search word. The intelligent recommendation service provides a service corresponding to the searched information based on various communication channels between the user terminal 100 and the connection terminal 200, such as a message service channel, and a Social Network Service (SNS) service channel, or the information transmitted and received in a predetermined communication channel.

The intelligent negotiation service collects and infers the negotiation information of the connection terminals 200 based on criteria information requested by the user terminal 100. For example, the intelligent negotiation service provides a date and time information for a scheduling function of the user terminal 100, collects response messages of the connection terminals 200, automatically negotiates and determines a reservation of a schedule, and distributes a result of the determination.

As described above, the system illustrated in FIG. 1 supports a service with minimum information exposure, i.e., without exposing information of the user terminal 100 to a server, by utilizing at least one of the above-described intelligent response service, intelligent information processing service, intelligent search service, intelligent recommendation service, and intelligent negotiation service, using an intelligent inference engine provided in the user terminal 100.

As a result, the system 10 of FIG. 1 supports various user terminals 100 to utilize an appropriate service at an appropriate level, while protecting private information.

The communication service device 300 forms a communication channel between the user terminal 100 and the connection terminals 200. In particular, the communication service device 300 supports transmission of data between the user terminal 100 and the connection terminal 200. The communication service device 300 may include various communication devices that support communication schemes according to the terminal attributes of the user terminal 100 and the connection terminals 200. For example, when the user terminal 100 and the connection terminals 200 are mobile communication terminals, the communication service device 300 may include a base station, a base station controller, and a mobile switching center. Further, the communication service device 300 may include a network device when one of the user terminal 100 and the connection terminals 200 supports a wired communication scheme. In particular, the communication service device 300 transmits and processes data so that P2P data transmission is performed between the user terminal 100 and the connection terminals 200.

The user terminal 100 connects to the connection terminal 200 through the communication service device 300, and processes and transmits signals in order to use at least one service of the intelligent inference engine. Accordingly, the user terminal 100 forms a communication channel with the connection terminals 200 according to each intelligent service form, and performs a data transmission and processing for a support of the intelligent service.

The connection terminals 200 forms a communication channel with the user terminal 100 using a P2P scheme through the communication service device 300, and provides data for supporting a service for the user terminal 100. The connection terminals 200 may be differently configured for each above-mentioned intelligent service. For example, when the user terminal 100 supports an intelligent response service using an intelligent inference engine, the connection terminal 200 performs a phone call to the user terminal 100. The connection terminals 200 transmits a connection request message for a call or a chatting service with the user terminal 100, and receives and outputs the above-mentioned intelligent response information, according to the processing of the user terminal 100.

When the user terminal 100 supports the intelligent information processing service using the intelligent inference engine, the connection terminal 200 provides information to the user terminal 100 through a message service channel, an e-mail service channel, a chatting service channel, etc. Further, the connection terminals 200 may provide certain information to the user terminal 100 by a voice, etc. The connection terminals 200 also forms a communication channel for providing information to the user terminal 100. The connection terminals 200 may be configured similarly to or different from the user terminal 100.

When the user terminal 100 supports an intelligent search service using an intelligent inference engine, the connection terminals 200 provide circumference search information for locations for which the user terminal 100 has requested support. Further, the connection terminals 200 may provide circumference search information for each of the corresponding locations. To this end, the connection terminals 200 may establish and store circumference search information for each of the locations that the user terminal 100 has requested, and automatically perform a search according to information requested by the user terminal 100. Further, when the user terminal 100 requests detailed information on detailed circumference search information or circumference search information on a specific location, the connection terminal 200 searches for the information and provides the information to the user terminal.

When the user terminal 100 supports an intelligent recommendation service using the intelligent inference engine, the connection terminals 200 establish a database for supporting an intelligent recommendation service. The connection terminals 200 search for information matched with specific information or information having at least one meaningful word among information transmitted to the user terminal, and searches for information related to the searched information. Further, the connection terminal 200 transmits the searched related information to the user terminal 100 in real time, at a certain time, or according to an occurrence of a certain event.

When the user terminal 100 supports an intelligent negotiation service based on an intelligent inference engine, the connection terminals 200 negotiate with the user terminal 100. The connection terminals 200 provide negotiation response information responds to the negotiation criteria information provided by the user terminal 100. In this process, one of the connection terminals 200 receives negotiation response information of another of the connection terminals, and integrates the negotiation response information of the one of the connection terminals 200 with the negotiation response information provided by the another of the connection terminals 200, according to the negotiation criteria information. The integrated negotiation response information may be transmitted to the another of the connection terminals 200, and a last connection terminal of the negotiation group may transmit the entire negotiation response information to the user terminal 100.

Further, each of the connection terminals 200 may provide the user terminal 100 with negotiation response information corresponding to the negotiation criteria information provided by the user terminal 100 by Peer-to-Peer (P2P).

As described above, the system illustrated in FIG. 1, provides various intelligent services to the user terminal 100, at an appropriate time, and in an appropriate form, using the intelligent inference engine in the user terminal 100. Accordingly, a user of the user terminal 100 may easily and quickly use optimized, personalized services through minimum terminal control, and in this process, the services may be utilized without revealing personal information to a server.

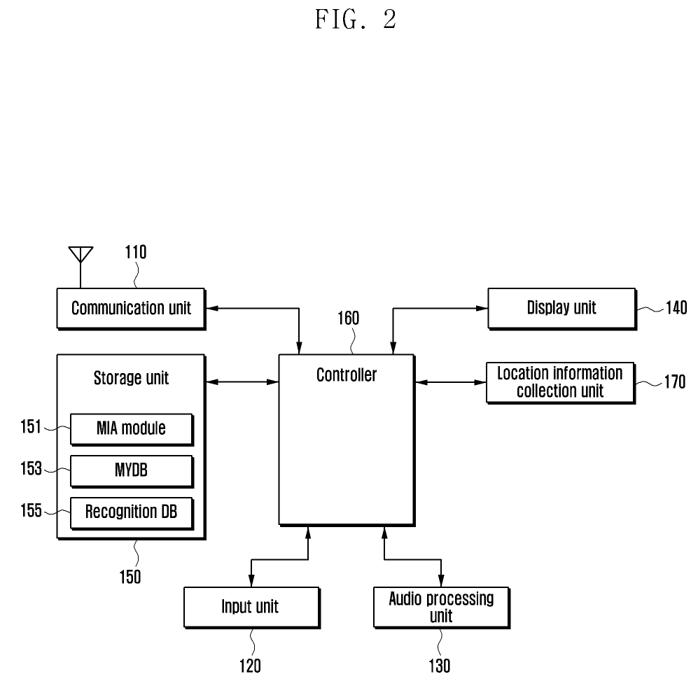

FIG. 2 illustrates a user terminal according to an embodiment of the present invention. Herein, the connection terminals 200 may have the same configuration as that of the user terminal 100 illustrated in FIG. 1, or may have specialized configurations for supporting specific intelligent services.

Referring to FIG. 2, the user terminal 100 includes a communication unit 110, an input unit 120, an audio processor 130, a display 140, a memory 150, a position information collection unit 170, and a controller 160. Herein, the term “unit” refers to a hardware device or a combination of a hardware device and software.

The communication unit 110 forms a communication channel with at least one of the connection terminals 200 through the communication service device 300. The communication unit 110 supports reception of information related to communication-based services without being limited to a specific communication technology. For example, the communication unit 110 may support Second Generation (2G), 3G, 4G, 5G, Time Division Multiple Access (TDMA), Code Division Multiple Access (CDMA), Wideband CDMA (WCDMA), Frequency Division Multiple Access (FDMA), Orthogonal FDMA (OFDMA), communication based on a wired or wireless network, etc.

In particular, the communication unit 110 may form a voice channel, a message channel, and/or a data channel with the connection terminal 200 through the communication service apparatus 300, either in real time, periodically, or in a fixed manner, depending on the type of the intelligent service.

The input unit 120 receives input commands for operating the user terminal 100, and may be formed as keys, such as a button key, a side key, a home key, etc., or may be provided as a touch screen. Here, the touch screen is disposed on the display unit 140 and supports generation of an input signal according to a user touch.

The input unit 120 generates an input signal for requesting activation of at least one of the intelligent services, and an input signal for searching information provided by an intelligent service. The generated input signal may be transmitted to the controller 160, and may operate as a command according to the corresponding to the function.

The audio processor 130 processes various audio signals related with the user terminal 100. Although not illustrated, the audio processor 130 include a speaker (SPK) for audio output and a microphone (MIC) for collecting audio.

The audio processor 130 outputs audio signals, when a communication channel is formed with the connection terminal 200. Basically, the audio processor 130 outputs audio alarms, notifications, sound effects, etc., for the user terminal 100. Further, when an audio signal is included in an effect sound or alarm sound according to activation of an intelligent service, and information according to a support of a specific intelligent service, the audio processor 130 may output the audio signal. For example, the audio processor 130 may output an audio signal for notification of activation of the service when an intelligent negotiation service is activated, an audio signal for notification of information related with the negotiation proceedings transmitted and received in the process of performing the service, and an audio signal for notification of the information related with the completion of the negotiation. Such an output of the audio signal may be omitted depending on user's setting.

The display 140, e.g., an Light Emitting Diode (LED) display or a Liquid Crystal Display (LCD), displays various screens for operation of the user terminal 100. For example, the display 140 outputs a screen for setting at least one intelligent service supported by the user terminal 100, and a screen for activating a set intelligent service. Here, the screen interface for activation of an intelligent service may become at least one of an intelligent response service user interface (UI), an intelligent information processing service UI, an intelligent search service UI, an intelligent recommendation service UI and an intelligent negotiation service UI. Each user interface may be changed respectively according to a conversion into various screens and an output of information.

The memory 150 stores various applications and programs for operation of the user terminal 100 or a specific terminal function. For example, the memory 150 stores an operating system for operation of the user terminal 100, a calling program for a call connection, a video call program for a video call, and a server connection program for an external server connection, etc. Herein, the memory 150 includes a Machine Intelligent Agent (MIA) module 151, a user database 153, and a recognition database 155 that support an intelligent service.

The MIA module 151 includes an intelligent inference engine for an intelligent service, and includes routines provided to control processing and branching of various data, transmission of data, etc. If an event for activation of the intelligent service occurs when the intelligent service has been set, the MIA module 151 is loaded to the controller 160, and may perform data processing for a support of an intelligent service.

The user database 153 stores information related with the user terminal 100, such as use history of the user terminal 100, information input by user, etc. For example, the user database 153 may include phonebook information, message storage information, e-mail storage information, schedule information, search history information, intelligent response information, map information, circumference search information, etc. The user database 153 including each set of the above-described information may be used by the controller 160 according to the calling of the MIA module 151.

The recognition database 155 includes information for a recognition function for the intelligent service support of the user terminal 100. For example, the recognition database 155 may include at least one of a voice recognition database and a text recognition database. The recognition database 155 may be used by the controller 160 in an environment in which a voice recognition and a text recognition are required in the process of supporting an intelligent service.

The recognition database 155 may include information on meaningful words. Here, meaningful words may be a text having a certain meaning.

The location information collection unit 170 collects the current location of the user terminal 100. The location information collection unit 170 may be formed by Global Positioning Satellite (GPS) module, etc.

The controller 160 controls the overall operation of the user terminal 100 and the above-described elements therein.

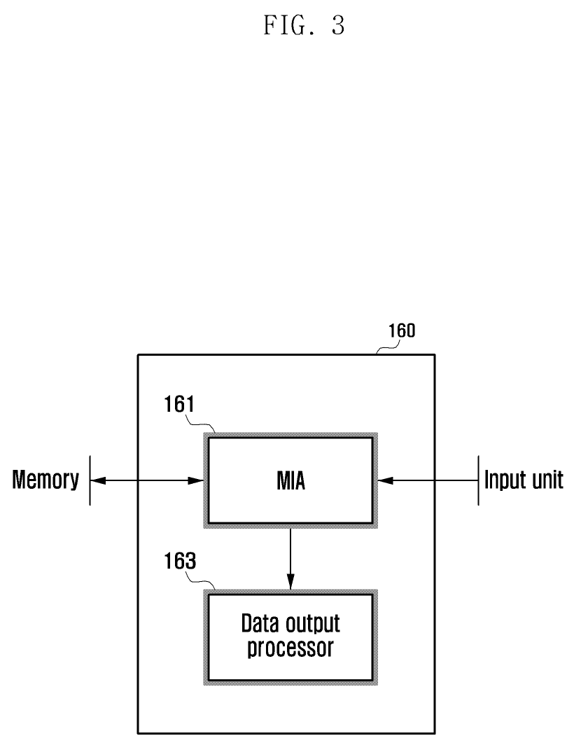

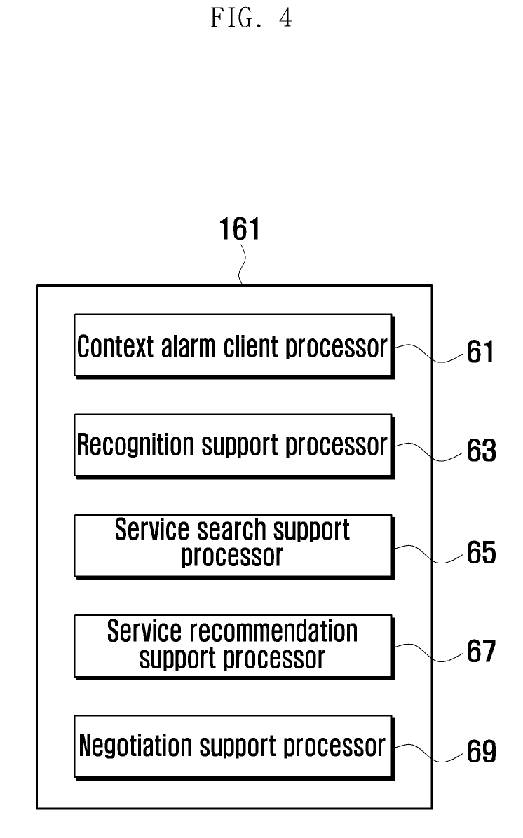

FIG. 3 illustrates a controller of a user terminal according to an embodiment of the present invention, and FIG. 4 illustrates a machine intelligent agent (MIA) according to an embodiment of the present invention.

Referring to FIGS. 3 and 4, the controller 160 includes an MIA 161 and a data output processor 163.

The data output processor 13 supports an output of various data related with the user terminal 100. The data output processor 163 may perform receiving information generated in the process of supporting the intelligent service of the MIA 161 and outputting the result of processing of the received information in the display unit 140. Further, the data output processor 163 may support a change of the information output according to the control of the MIA 161.

The MIA 161, an intelligent inference engine, performs overall signal processing of the user terminal 100 for the intelligent service, e.g., setting of a service, determination of support, etc. The MIA 161 may set at least one of various intelligent services by providing a setting screen interface for the setting the intelligent service. For example, the MIA 161 provides a list screen for selecting at least one of the above-described intelligent services, to turn on or off a specific intelligent service setting, or may provide an icon or widget to turn on or off each intelligent service setting.

Further, if an event related with the intelligent service occurs when a specific intelligent service has already been set, the MIA 161 may control to operate the intelligent service based on the occurred event. Accordingly, the MIA 161 may include a context alarm client processor 61, a recognition support processor 63, a service search support processor 65, a service recommendation support processor 67, and a negotiation support processor 69.

If there is a request, such as a call connection from the connection terminal 200, when an intelligent response service has been set, the context alarm client processor 61 collects the current location information of the user terminal 100, searches for information related with the location, or receives and checks information related with the location from the specific information providing server. Thereafter, the context alarm client processor 61 collects response information to be provided to the connection terminal 200 in response to the location, and transmits the collected response information to the connection terminal 200.

For example, when the current location is determined as a library, the context alarm client processor 61 collects corresponding response information and transmits the collected response information to the connection terminal 200. Specifically, the context alarm client processor 61 controls a call request from the connection terminal 200 to be automatically silent or rejected. Here, the response information may be information stored in the user database 153 by a user's advance definition or information requested by connection to the information providing server device, which provides the information.

The recognition support processor 63 supports at least one of a voice recognize and a text recognition related with the user terminal 100. In particular, the recognition support processor 63 supports text recognition in connection with an intelligent information processing service. That is, if a text message or an e-mail message is transmitted from at least one of the connection terminals 200, the recognition support processor 63 parses the content of the message, and determines whether the content includes a predefined word or certain number information.

The service search support processor 65 collects the current location information of the user terminal 100 when an intelligent search service has been set. The service search support processor 65 activates the location information collection unit 170. Further, if the location information is searched, the service search support processor 65 may provide support to collect circumference search information within a certain radius on the basis of the location, and output the collected information. Further, the service search support processor 65 collects and provides more detailed circumference search information, based on the location change of the user terminal 100, and supports a search information update according to a movement direction.

For a voice signal, which is recognized by the recognition support processor 63, transmitted and received in one of the connection terminals 200, and contains at least one meaningful word, the service commendation support unit 67 provides support to collect information related with the word. The service recommendation support processor 67 searches for information related with the meaningful word in the user database 153, or may request information related with the meaningful word from the specific information providing server device.

In the collection process, the service recommendation support processor 67 provide related information for each word, related information for a plurality of words, or information related with the entire words, or may extract common elements of the related information and recommend the extracted elements to user. Further, the service recommendation support processor 67 parses at least one word from a transmitted/received or written text information, and a voice signal using the recognition support processor 63, and collects and outputs information related with each of the parsed words or a combination thereof.

The negotiation support processor 69 supports a negotiation of various sets of information according to a request of user who uses the user terminal 100. For example, the negotiation support processor 69 supports to transmit negotiation criteria information by user to the connection terminals, which are designated by a user or belong to a certain group. Thereafter, the negotiation support processor 69 checks negotiation response information transmitted from at least one of the connection terminals 200, and produces negotiation determination information in the negotiation response information. If the negotiation determination information is produced, the negotiation support processor 69 transmits the negotiation determination information to the at least one connection terminals 200. Accordingly, the negotiation support processor 69 automatically or easily performs schedule negotiation, price negotiation, etc. The negotiation support processor 69 supports to collect and apply preference information of each of the connection terminals 200 before generation of the negotiation determination information.

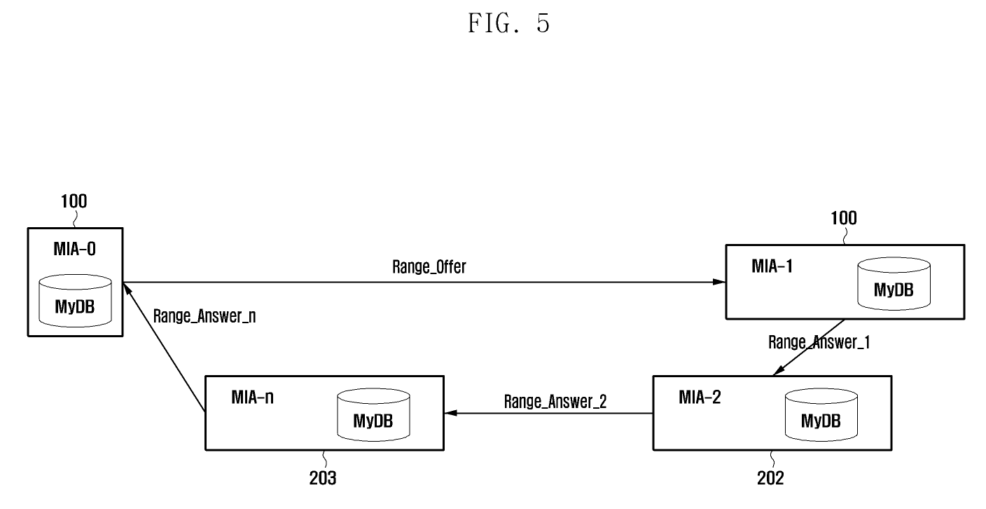

FIGS. 5 to 8 illustrate data transmission and processing during an intelligent negotiation service according to embodiments of the present invention. In FIGS. 5 to 8, it is assumed that a user using the user terminal 100 desires to make a schedule by designating certain negotiation criteria information, e.g., a certain date within 2 weeks, with a plurality of the connection terminals 200. Additionally, although the description of FIGS. 5 to 8 is based on the date, “date” may be substituted by time information. That is, a certain time range of a certain date, on which user desires to make a schedule, may be provided as criteria information of the negotiation.

Referring to FIG. 5, the user terminal 100 transmits an offer message (Range_Offer) related with the schedule reservation to connection terminal 201. Herein, the offer message (Range_Offer) includes criteria information of the negotiation intended by the user terminal 100, i.e., information corresponding to a certain time range of 2 weeks. Further, the offer message (Range_Offer) may include information of other connection terminals 200 to participate in the negotiation.

The connection terminal 201 receives the offer message from the user, writes the first negotiation response message (Range_Answer_1) on the received offer message, and transmits the written first negotiation response message to connection terminal 202, according to a round robin scheme. The first negotiation message includes the content of the offer message, and also includes a scheduling possible date range by the connection terminal 201. Further, the first negotiation response message may include information on other connection terminals 202, . . . , 20n to participate in the negotiation, and the user terminal 100.

The connection terminal 201 includes an intelligent inference engine, and parses the content of the offer message transmitted from the user terminal 100 and writes the first negotiation response message on the schedule reservation. That is, the intelligent inference engine of the connection terminal 201 extracts empty schedule information within the range on the basis of the schedule information already stored in the connection terminal 201 and the range information in the negotiation criteria information, and writes the first negotiation response message based on the extracted information. For example, the intelligent inference engine of the connection terminal 201 may automatically write the first negotiation response message based on the schedule information of the user of the connection terminal 201 in a situation in which there is no separate user input. Further, if the writing of the first negotiation response message is completed, the connection terminal 201 may perform an output using the display, etc., for confirmation of the completion of the first negotiation response message and the transmission thereof. As such, the user of the connection terminal 201 may confirm whether a negotiation on a certain subject is ongoing, and may control a continuous progress of the negotiation through the acceptance of the confirmation. Further, the connection terminal 201 may automatically perform an overall negotiation process, and notify user of only the negotiation result by an image or audio signal using the display unit or audio processing unit, etc.

In addition, the connection terminal 201 may provide the priority level for each date as well as the writing of empty schedule information in the process of writing of the first negotiation response message. Here, the priority level may be automatically produced on the basis of certain date information and the general schedule history information of the user. For example, the connection terminal 201 may operate so that there would be no schedule during weekends by giving relatively a low priority to the dates, even if the schedule for certain dates like weekends is empty. Here, certain dates may be user-related information such as celebration days, vacation days, special monthly leaves, etc., and such dates may be divided according to information.

Further, when a user history indicates that a user has regularly performed a certain schedule in a certain date, the priority information of the date may be set relatively high or low. For example, even when a certain schedule is not disclosed in the date within the range of the negotiation criteria information and there is a regular record, the connection terminal 201 may set the priority information of the date relatively low so as not to have a schedule on the date. Further, when there is a prewritten schedule in the dates within the range of the negotiation criteria information, the connection terminal 201 may set the priority information of the date relatively low, or write the first negotiation response message not to have a schedule.

Further, the priority level may be designated by the user. For example, the connection terminal 201 may provide the user with a screen interface for designating priority levels for dates without schedule within the range of the negotiation criteria information. Further, the connection terminal 201 may provide a screen interface for designating the priority level of a certain date desired by user within the range of the negotiation criteria information.

The connection terminal 201 transmits to the connection terminal 202, the first negotiation response message (Range_Answer_1) written by user's request or through the above-described intelligent inference. More specifically, the connection terminal 201 collects the information of the connection terminal 202 by checking the offer message, and provides the first negotiation response message to the connection terminal 202, based on the collected information.

The connection terminal 202 writes the second negotiation response message (Range_Answer_2), after performing a process similar to the process performed when the connection terminal 201 writes the first negotiation response message. Here, the second negotiation response message includes information of reservation-possible schedule written by the connection terminal 202, along with the first negotiation response message. The connection terminal 202 transmits the written second negotiation response message to a next connection terminal, for example, the nth terminal 20n. Accordingly, the connection terminal 202 may transmit the second negotiation response message in the content of the first negotiation response message, collect the connection terminal information, and transmit the second negotiation response message using the collected information.

The nth connection terminal 20n also performs the same process as that in the connection terminal 202. That is, the nth connection terminal 20n writes the nth negotiation response message (Range_Answer_n) and transmits the written message to the user terminal 100. At this time, the nth connection terminal 20n may check connection terminal information to be transmitted next within the received negotiation response message. Further, when there is no next connection terminal for transmitting a message, the nth connection terminal 20n transmits the nth negotiation response message to the user terminal 100.

While performing the above-described process, the connection terminals 201, 202, . . . , 20n may respectively perform a process for checking the user's procedure, automatically perform the entire process without a separate confirmation process, and provide only the negotiation result to each terminal user.

Further, although FIG. 5 is described above using a round robin scheme, the present invention is not limited thereto. For example, the user terminal 100 may provide the offer message to each of the connection terminals 201, 202, . . . , 20n, and may use a multiple one to one scheme, which requests transmission of the negotiation response message by one to one from each of the connection terminals 201, 202, . . . , 20n. Accordingly, the user terminal 100 may transmit the offer message including the negotiation criteria information to each of the connection terminals 201, 202, . . . , 20n, and receive a negotiation response message corresponding to the offer message from each of the connection terminals 201, 202, . . . , 20n. Te negotiation response message, which is provided to the user terminal 100 by each of the connection terminals 201, 202, . . . , 20n, does not include the negotiation response message of another connection terminal, but may include only its own negotiation response message.

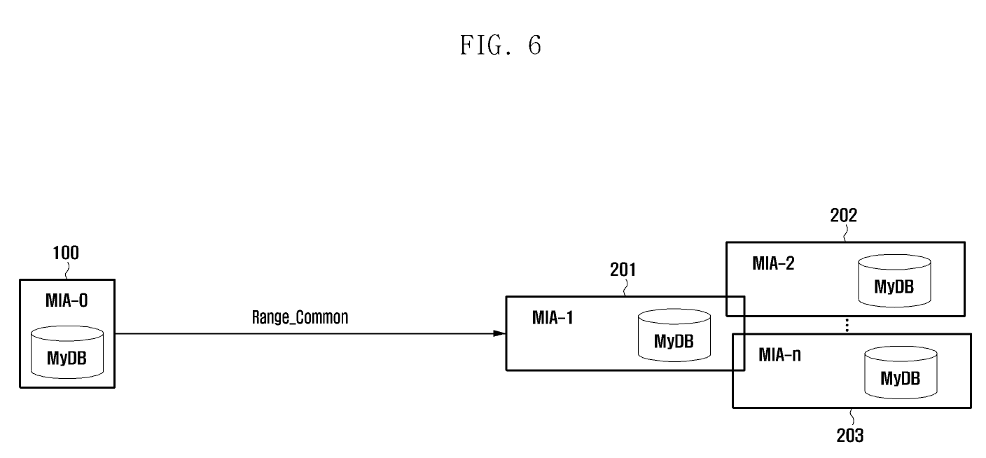

Referring to FIG. 6, the user terminal 100 parses the content of the negotiation response message collected from the nth connection terminal 20n or the negotiation response message received from each of the connection terminals 201, 202, . . . , 20n, and writes a common range message (Range_Common) based the parsed content. For example, the common range message includes reservation-possible schedule information and priority level information written in the negotiation response message of each of the connection terminals 201, 202, . . . , 20n. That is, the common range message includes information including one or more dates on which the schedule may be reserved in all or part of the connection terminals 201, 202, . . . , 20n which participate in the negotiation.

For example, the common range message may include information of the schedule in which all connection terminals 201, 202, . . . , 20n may participate in a certain schedule within two weeks. Further, the common range message may include the content of the entire response message written by each of the connection terminals 201, 202, . . . , 20n within 2 weeks. Further, the common range message may also be transmitted to the connection terminals 201, 202, . . . , 20n through the above described round robin scheme or a multiple one to one scheme.

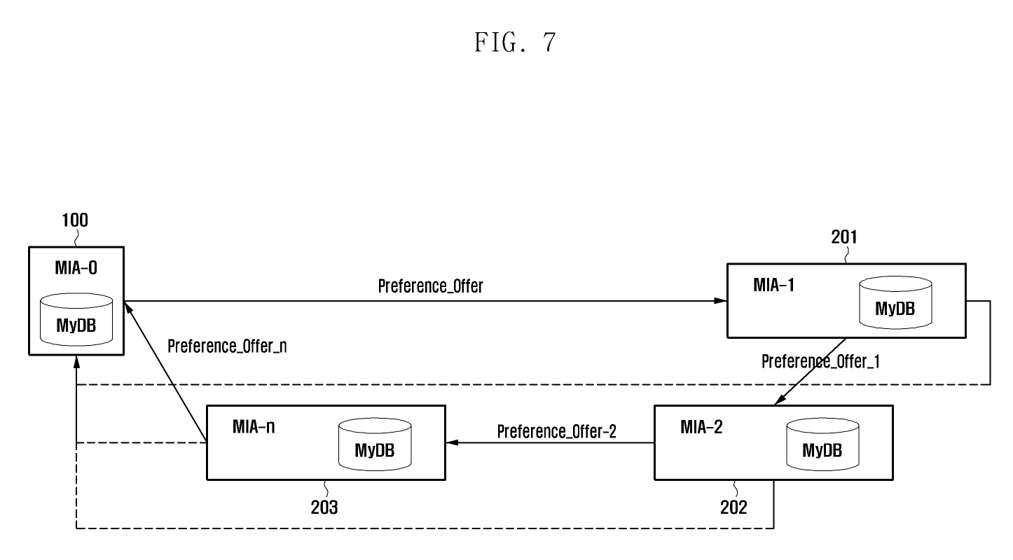

Referring to FIG. 7, the user terminal 100 transmits the preference offer message (Preference_Offer) to the connection terminal 201. The preference offer message includes negotiation criteria information for collecting negotiation response information preferred by each of the connection terminals 201, 202, . . . , 20n. The negotiation criteria information included in the preference offer message may become the same date information as that included in the common range message described in FIG. 6, or part of the information.

The connection terminal 201, which has received the preference offer message from the user terminal 100, writes the first preference response message (Preference_Answer_1) by reflecting the preference criteria information included in the preference offer message and the personal preference based on the pre-inputted information or terminal use history of the terminal user. The intelligent inference engine of the connection terminal 201 automatically writes the first preference response message based on the terminal use history of the user. That is, the intelligent inference engine checks the schedule information of the connection terminal 201, while writing the first preference response message, and designates the preferred dates.

Further, when generating a recurring schedule, the intelligent inference engine may designate dates including previously scheduled time as preferred dates. Here, the intelligent inference engine may check the negotiation criteria information in the preference offer message in order to confirm the recurring schedule.

Further, the intelligent inference engine may extract information related with the schedule in the negotiation criteria information, and search for the previous scheduling record having correlation with the information. Accordingly, the preference offer message provided by the user terminal 100 may include schedule-related information, for example, the subject of the schedule, the purpose of the schedule, information on the number of people related with the schedule, etc.

Thereafter, the connection terminals 201, 202, . . . , 20n extract the information, and write each preference response message by designating a certain date within the period included in the negotiation criteria information as a preferred date on the basis of the extracted information.

The connection terminal 201 transmits the written first preference response message to the connection terminal 202 according to a round robin scheme. The connection terminal 202 writes a second preference response message (Preference_Answer_2) through an inference scheme, similar to that of the connection terminal 201. The written second preference response message is transmitted to the nth connection terminal 20n, which is the next connection terminal. The nth connection terminal 20n may also write the nth preference response message through an inference scheme similar to that of the connection terminal 202. The written nth preference response message (preference_Answer_n) may be transmitted to the user terminal 100. The nth connection terminal 20n may write a preference response message including only its own preference information, as in the previous connection terminals, or may write the preference response message by checking the content of the preference response message transmitted by the previous connection terminals and reflecting the checked content. The method of writing its own preference response message by referring to the preference response message of the previous connection terminal may be commonly applied to all connection terminals, or may only apply to certain terminals according to the setting of each of the connection terminals 201, 202, . . . , 20n.

Although message transmission has been described above using a round robin scheme, the present invention is not limited thereto. As described above, the user terminal 100 may write the preference offer, and then transmit the written preference offer to each of the connection terminals 201, 202, . . . , 20n by a multiple one to one scheme. Further, the user terminal 100 may then receive the preference response message written by each of the connection terminals 201, 202, . . . , 20n by one to one.

When the process described with reference to FIG. 7 is performing, the process of FIG. 6 may be omitted during an intelligent negotiation service of the present invention.

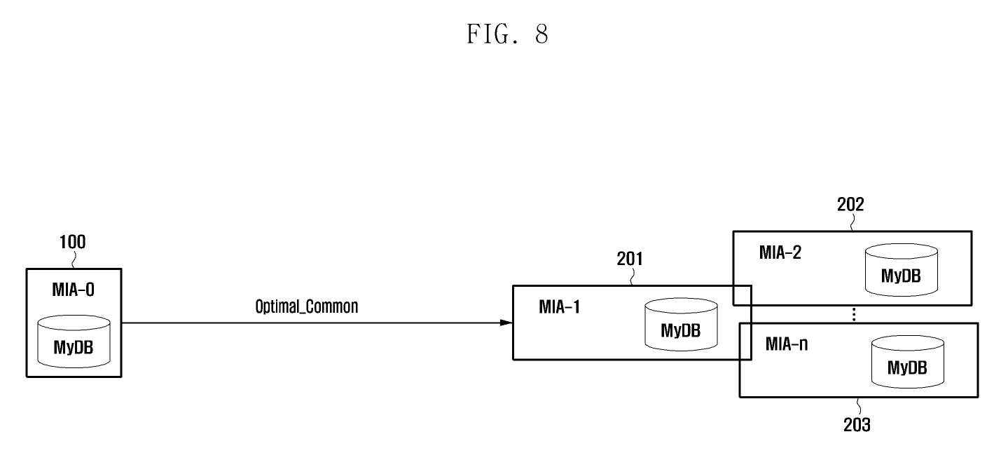

Referring to FIG. 8, the user terminal 100 checks the preference response message received from the connection terminals 201, 202, . . . , 20n, and determines schedule reservation dates from the preference response message. If the schedule reservation date is determined, the user terminal 100 writes the common optimal message (Optimal_Common), based on the determined schedule reservation date information, and transmits the written common optimal message to the connection terminals 201, 202, . . . , 20n. More specifically, the intelligent inference engine of the user terminal 100 checks the collected preference response messages, respectively, and determines the date, when the preference information of the connection terminals 201, 202, . . . , 20n is overlapped, as the schedule reservation date. Herein, the intelligent inference engine of the user terminal 100 determines a date, on which all of the preference information sets of the connection terminals 201, 202, . . . , 20n are overlapped, as a certain date of the week in a random scheme, and when there is no all overlapped date, the date, on which the largest amount of preference information sets are overlapped, may be determined as the schedule reservation date.

Further, the intelligent inference engine of the user terminal 100 transmits the common optimal message including the schedule reservation date to each of the connection terminals 201, 202, . . . , 20n in at least one of a round robin scheme and a multiple one to one scheme.

Alternatively, the connection terminals 201, 202, . . . , 20n may designate dates on which schedule participation is possible, and the time preferred on the dates may be set.

Further, in the above-described intelligent negotiation service, some steps may be automatically performed without user control, and some of the remaining steps may be performed according to user's confirmation.

Further, as mentioned above, the entire negotiation step may be automatically performed, and the negotiation result is output.

Further, when the user terminal 100 provides an offer message corresponding to the negotiation criteria information and receives the negotiation response information from the connection terminals, the user terminal 100 may generate negotiation determination information based on the received negotiation response information and complete the negotiation without transmitting the common range information and receiving the preference response message. As such, receiving the negotiation response information and generating the negotiation determination information may be understood as a form that further includes receiving the preference response message on the common range message, and generating the negotiation determination information based on the received preference response message.

Further, although a method of selecting a schedule date has been described above, the present invention is not limited thereto. That is, various intelligent services, such as a price negotiation service, which determines the price of something, a place negotiation service, which determines a certain region or place, a number negotiation service, which determines, e.g., a number of people may also be provided through a negotiation with the connection terminals 200, based on the above-described intelligent inference engine.

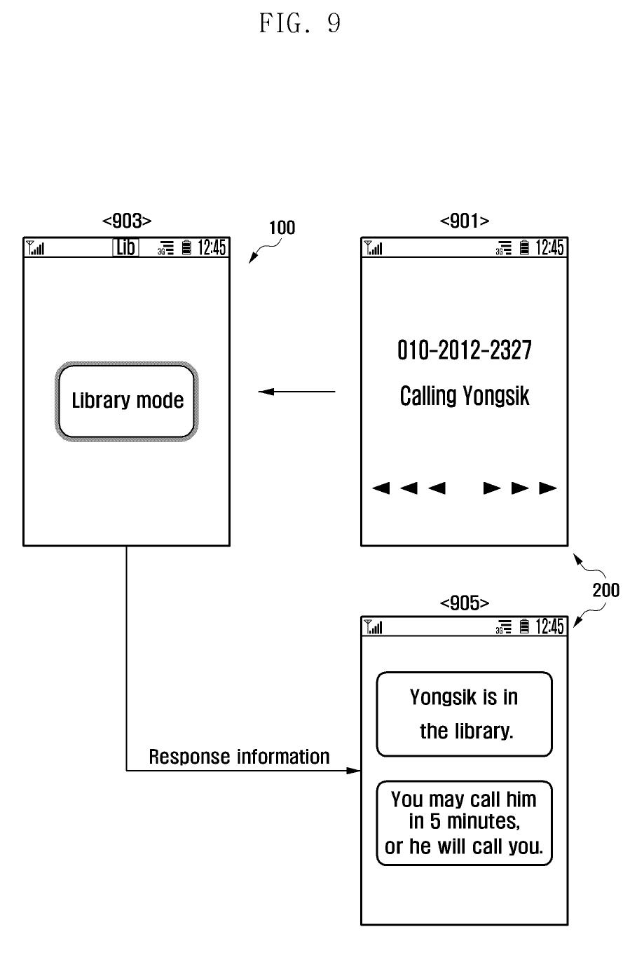

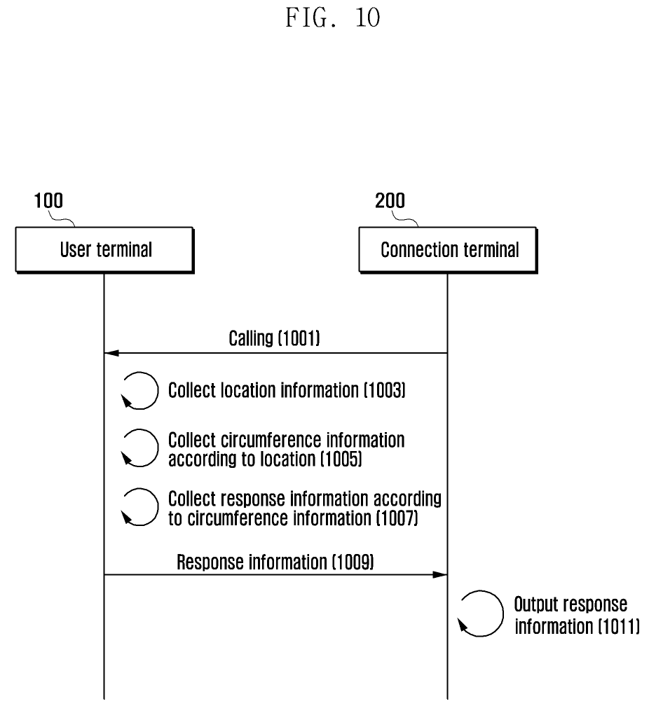

FIG. 9 illustrates examples of screens displayed on a user terminal during an intelligent response service according to an embodiment of the present invention, and FIG. 10 is a signal flow diagram illustrating an intelligent response service according to an embodiment of the present invention.

Referring to FIGS. 9 and 10, the connection terminal 200 calls the user terminal 100 in step 1001. The connection terminal 200 checks the phonebook list to select the phone book information corresponding to the user terminal 100, or enters the phone number corresponding to the user terminal 100. Thereafter, the connection terminal 200 outputs a call connection screen 901, displaying a call connection to the user terminal 100.

When a call connection service is performed from the connection terminal 200, the user terminal 100 collects position information in step 1003. For example, the user terminal 100 activates the location information collection unit 170 to collect the current location information.

After the current location information is collected, the user terminal collects circumference information according to the location in step 1005. For example, the intelligent inference engine of the user terminal 100 may search for map information that provides a circumference related with the location information. The map information may be stored in the memory 150 of the user terminal 100, or may be provided by an external certain connection terminal. As such, the intelligent inference engine collects information related with the current location by using the map information stored in the memory 150 or the map information provided by the external certain connection terminal. For example, the intelligent inference engine collect “library” information as the current location, which is output as “library mode” in screen 903.

In step 1007, the user terminal 100 collects response information according to the circumference information. For example, the intelligent inference engine may collect the circumference information, that is, response information corresponding to “library” information with reference to the user database 153. Here, when there is no “library”-related response information in the user database 153, the intelligent inference engine may perform a connection to an external certain connection terminal which provides the response information related with the information, and collects response information provided by the certain connection terminal.

If the response information collection is completed, the user terminal 100 transmits the collected response information to the connection terminal 200 in step 1009.

In step 1011, the connection terminal 200 outputs the received response information in screen 905. For example, the connection terminal 200 outputs response information “Yongsik is in the library. You may call him in 5 minutes, or he will call you.” in connection with the user information of the user terminal 100. The response information may be information automatically collected in connection with the current location information by the intelligent inference engine of the user terminal 100.

Although FIGS. 9 and 10 illustrate the user terminal 100 outputting the information indicating “library mode” in screen 903, the output the information may be omitted.

Further, when the user terminal 100 receives a call connection request from the connection terminal 200, the user terminal 100 outputs the reception in the display unit so that the user may recognize that there is an incoming call from the connection terminal 200.

Further, although the user terminal 100 collects the location information, circumference information and response information after the connection terminal 200 performs a call connection in FIGS. 9 and 10, the present invention is not limited thereto. For example, the user terminal 100 may collect location information, and collect circumference information and response information based on the location information, before the connection terminal 200 requests a call connection in steps 1003 to 1007.

Further, although the user terminal 100 is in the library in FIGS. 9 and 10, the user terminal 100 may be in another location, such as on a road, in a car, on a ship, at a school, in a meeting room, in a restroom, etc. Further, the division of the location information, such as a meeting room and a restroom may be provided through the section identifier installed by floors or sections. Here, the section identifier may be a wireless connection point or tag installed for each section.

Further, when each set of location information and circumference information becomes different, the response information collected corresponding to the information may also become different. The response information may become different according to the time even for the same location information and circumference information. The response information, which becomes different according to the location information, circumference information, time information, etc., may be defined and stored in the user database 153 in advance, and may be referred to, or may be provided or collected by an external certain connection terminal.

As described above, the intelligent response service checks the current location of the user terminal 100, collect various response information, which may be responded by the user terminal 100, and provides the collected response information to the connection terminal 200, thereby providing the collected response information to the connection terminal 200, and drawing appropriate situation inference and the following action.

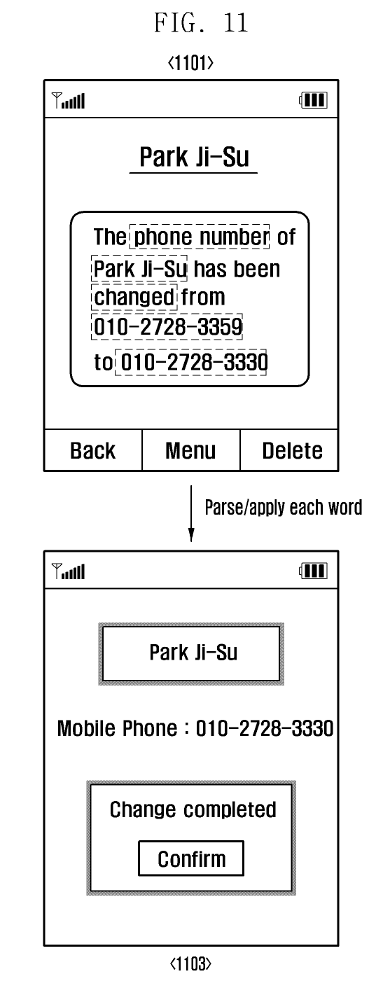

FIG. 11 illustrates examples of screens displayed on a user terminal during an intelligent information service according to an embodiment of the present invention.

Referring to FIG. 11, first, the user terminal 100 receives text information through a message service, an e-mail service, etc., from the connection terminal 200 in screen 1101. In this example, the user terminal 100 receives text information that “the phone number of Park Ji-Su has been changed from 010-2728-3359 to 010-2728-3330” from the connection terminal 200.

Further, the intelligent inference engine of the user terminal 100 performs letter recognition on the text information. For example, the intelligent inference engine extracts meaningful words, such as “Park Ji-Su”, “phone number”, “010-2728-3359”, “010-2728-3330”, and “changed” from the text information. Thereafter, the intelligent inference engine refers to the user database 153 stored in the memory 150. The user database 153 may include data on each meaningful word in order to support the intelligent information processing service of the present invention.

Further, the intelligent inference engine may store parsed information in the memory 150 of the user terminal 100. For example, when the phonebook information related with the “Park Ji-Su” is stored in the user database 153, the intelligent inference engine updates the information in the user database 153.

Further, the intelligent inference engine of the user terminal 100 outputs the information update screen in the display, so that user may check the information update screen as in screen 1103. User may check whether an information update has occurred in the user database 153 through the screen information. At this time, user may determine whether or not to perform an information update.

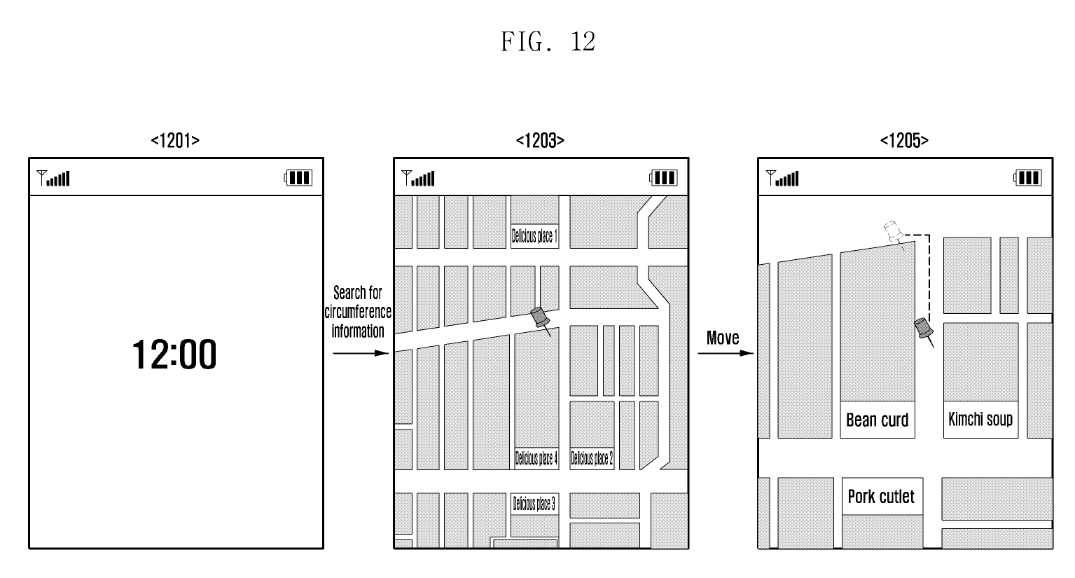

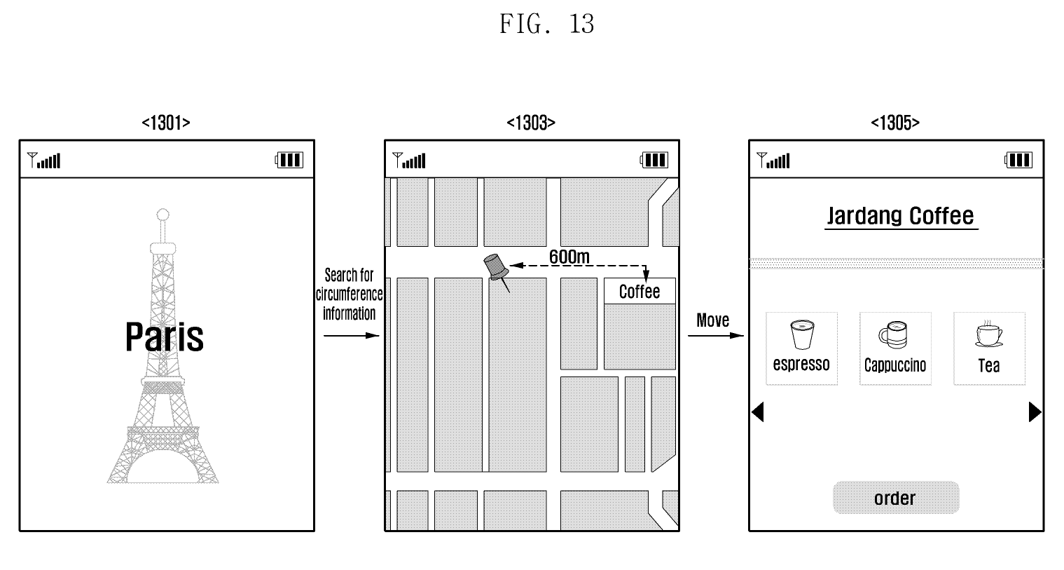

FIGS. 12 and 13 illustrate examples of screens displayed on a user terminal during an intelligent search service according to an embodiment of the present invention.

Referring to FIG. 12, the user terminal 100 outputs the current time information in screen 1201. Further, the user terminal 100 determines whether the current time is a predefined time to support an intelligent search service according to a previous user setting. When the current time is a preset time, for example, 12:00 o'clock as in screen 1201, the user terminal 100 performs a circumference search function as illustrated in screen 1203. More specifically, the user terminal 100 activates the location information collection unit 170 to collect the current location information, and searches for the circumference, based on the map information stored in the memory 150 or map information provided by a certain external connection terminal. The user terminal 100 may automatically filter and output certain information among the circumference search information according to predefined settings.

Further, the intelligent inference engine of the user terminal 100 may check the terminal function and time mainly used by the user, and automatically support the performance of the function based on the checked function and time. For example, when user searches for a restaurant in a current area each day at 12:00 o'clock, e.g., more than a certain number of times, the intelligent inference engine of the user terminal 100 searches for the circumference information, and filters and outputs restaurants in the current area at 12 o'clock or a certain period of time before 12 o'clock.

Further, when the user terminal 100 moves, the intelligent inference engine of the user terminal 100 may re-filter the results based on the movement, as illustrated in screen 1205.

The user terminal 100 may store map information including circumference search information and detailed circumference information, or may receive the map information from an external certain connection terminal in order to provide the above-described circumference search information and detailed circumference information.

For example, the above-described intelligent search service may also support other service in a an area, such as a bus search or a subway search. That is, when a preset time comes, the intelligent search service of the present invention may automatically search for estimated bus arrival time or subway arrival time information at a certain station, and provided the searched information. In the case of a bus station, there may be several bus stations around the spot where the user terminal 100 is located. In this case, it is possible to provide all estimated arrival times of buses, which will arrive at each station, or it is also possible to provide only the estimated arrival time of the bus having the number mainly used by user.

Further, the user terminal 100 may be disposed at a certain location, e.g., Paris, France, as illustrated in FIG. 13. In this case, the user terminal 100 displays information related with the location of the user terminal 100, as illustrated in screen 1301. The function of displaying the current location information of the user terminal 100 may be omitted according to the terminal setting.

Further, when a user terminal 100 is located in a specific location, the intelligent inference engine of the user terminal 100 may search for the circumference information, filter information needed by user among the searched circumference information, and output the information in the display unit.

For example, when the user has a record of searching for a store, for example, a coffee house, at a certain spot, or requests an input for the search, the intelligent inference engine of the user terminal 100 may automatically search for the circumference information at a certain location, filter information having a searched record among searched information, and output the filtered information as illustrated in screen 1303. Further, the user terminal 100 may display information on the distance and direction up to the searched information from the current location of the user terminal 100. At this time, the intelligent inference engine may provide the distance and direction information between the closest information and the current user terminal 100, or the distance and direction information between the circumference information mainly used by user and the user terminal 100. The circumference information mainly used by user may be checked through the purchasing record information of user, etc.

Further, when the user approaches an area within a predetermined distance from the circumference information, the user terminal 100 may automatically activate an application for purchasing products sold in the circumference information. For example, the user terminal 100 may output an application screen for purchasing products sold in a store corresponding to the certain circumference information as illustrated in screen 1305.

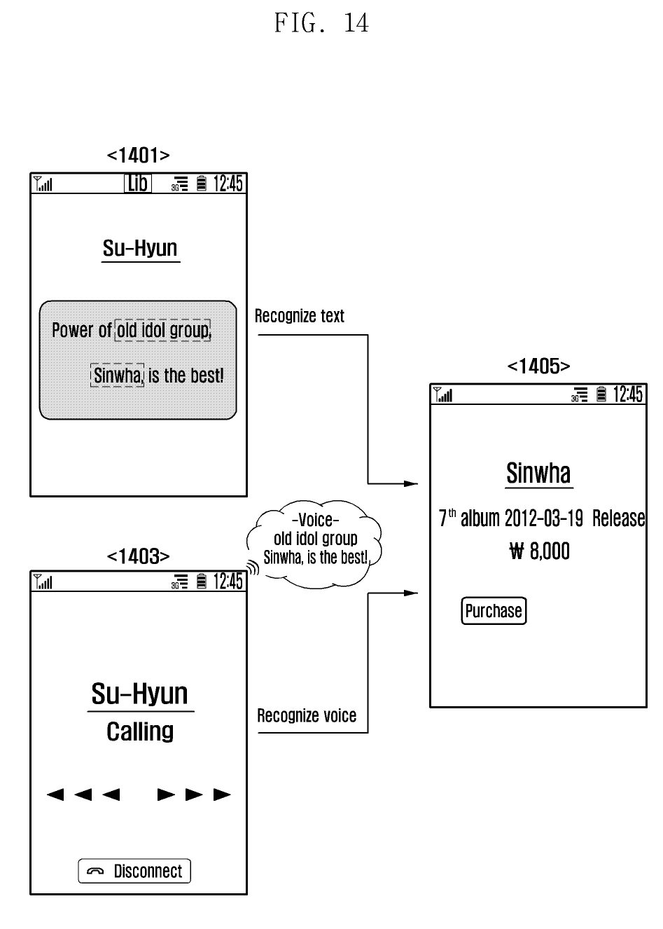

FIG. 14 illustrates examples of screens displayed on a user terminal during an intelligent recommendation service according to an embodiment of the present invention.

Referring to FIG. 14, the user terminal 100 receives text information from the connection terminal 200, as illustrated in screen 1401, or may transmit and receive voice communication to and from the connection terminal 200.

The user terminal 100 forms a chatting channel with the connection terminal 200 or receives text information through a message service channel or an e-mail service channel with the connection terminal 200. For example, the user terminal 100 receives text information, “Power of old idol group, Sinwha, is the best!” The user terminal 100 performs text recognition by parsing words “old idol group” and “Sinwha” from the text information. Thereafter, the intelligent inference engine of the user terminal 100 refers to at least one of the recognition database 155 and user database 153 stored in the memory 150. Further, the intelligent inference engine of the user terminal 100 may use an external connection terminal, which is separately provided for text recognition, from the text information. The recognition database 155 and user database 153 may include information on meaningful words for the text recognition as explained above.

Further, the user terminal 100 may perform a certain voice call with the connection terminal 200 as illustrated in screen 1403. In this case, the intelligent inference engine of the user terminal 100 may recognize at least part of the transmitted and received voice during the voice call. In this process, the user terminal 100 parses meaningful expressions, i.e., “old idol group” and “Shinwha”.

Thereafter, the user terminal 100 performs a related search based on parsed words, and the intelligent inference engine of the user terminal 100 connects to the external certain connection terminal and searches for the related information based on the parsed words. Further, when the search of the related information is completed, the user terminal 100 output the related information in the display unit as illustrated in screen 1405.

As described above, the user terminal 100 parses transmitted and received information, and automatically searches for the information related to the parsed information in order to intelligently provide the searched information to user.

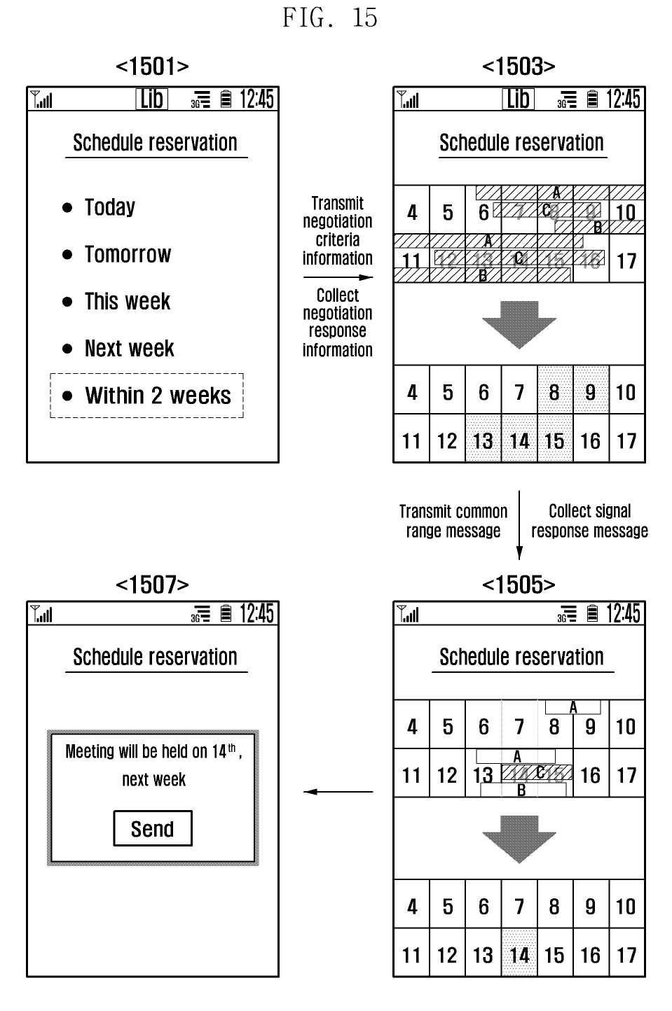

FIG. 15 illustrates examples of screens displayed on a user terminal during an intelligent negotiation service according to an embodiment of the present invention.

Referring to FIG. 15, the user terminal 100 activates a schedule reservation function and outputs a screen as illustrated in screen 1501. For example, the user terminal 100 provides a screen for selecting various items, such as today's schedule reservation, tomorrow's schedule reservation, this week's schedule reservation, next week's schedule reservation, schedule reservation within two weeks, etc. Further, the user terminal 100 may provide a screen interface for designating a specific date or date range in order to support the date designation schedule reservation function.

Further, the user terminal 100 may select the negotiation criteria information and write an offer message including the negotiation criteria information based on the selected information through the schedule reservation function screen. The written offer message may be transmitted to other connection terminals designated by user. Thereafter, if negotiation response information on the offer message is received from other connection terminals, the user terminal 100 outputs the received negotiation response information, as illustrated in screen 1503. The user terminal 100 may output the entire negotiation response information of the connection terminals in one screen, and output the common range information, which belongs to the common range, based on the negotiation response information, in a separate screen area.

Thereafter, the user terminal 100 may write the common range message based on the information, which belongs to the common range, and transmit the written common range message to each connection terminal. Thereafter, the user terminal 100 may receive the preference response message corresponding to the common range message from the connection terminals. The preference response message includes information preferred by each connection terminal, and the connection terminals may use each arranged intelligent inference engine and information stored in user in advance in order to include the preference information. Further, if a preference response message is received from the connection terminals, the user terminal 100 outputs the received message, as illustrated in screen 1505.

In screen 1505, the user terminal 100 displays an area for all preference information included in the preference response message received from each connection terminal, and a determination area for determining a specific date as a schedule reservation date among all disclosed preference information. If a specific date is determined as the schedule reservation date, the user terminal 100 outputs the schedule reservation result, as illustrated in screen 1507.

The above-described process may be automatically performed by the intelligent inference engine, and the process of transmitting the last schedule reservation result to other connection terminals may also be automatically performed.

Further, when a user's confirmation process is required at each process or user has set the confirmation process, the intelligent inference engine may output screens 1505 and 1507, asking whether to complete the process. As such, the user using the user terminal 100 may arbitrarily change the determined date provided by the intelligent inference engine to another date in screen 1505. Further, user may perform confirmation related with transmitting the determined date to each connection terminal, as illustrated in screen 1507.

As described above, a method, terminal, and system for providing a communication-based service provide information to a user while minimizing terminal control by intelligently providing information to the user at an appropriate time point. As such, the user may easily utilize a service desired by user himself through simple control of the terminal.

Further, the above-described user terminal and connection terminals may further include various additional modules depending on the provided type. That is, the terminals may further include components, which were not mentioned above, such as a Near Field Communication (NFC) module for near field communication, an interface for data transmission and reception by a wired communication scheme or wireless communication scheme of the terminals, an Internet communication module for performing an Internet function by communication with an Internet network, and a digital broadcast module for receiving and replaying a digital broadcast, etc. Such components may be variously modified according to the convergence trend of digital devices, and thus not all of such components may be listed here, but components of the same level as that of the above mentioned components may be additionally included in the device. Further, the terminals of the present invention exclude some components from the above-described configuration, or may be substituted by another configuration. This will be easily understood by those skilled in the art.

Further, the terminals according to the above-described embodiments of the present invention may include all information communication devices and multimedia devices such as a Portable Multimedia Player (PMP), a digital broadcast player, a Personal Digital Assistant (PDA), a music player (e.g., an MP3 player), a portable game console, a smart phone, a notebook computer and a handheld PC, etc., as well as all mobile communication terminals operated according to communication protocols corresponding to various communication systems.

As described above, according to a communication-based service providing system using an intelligent inference engine and a terminal supporting the same of the present invention, user's convenience is improved by allowing a service optimized for each terminal to be appropriately provided depending on the situation of the terminal.

Further, the present invention may intelligently process and provide a service to a user, while minimizing user control.

Although certain embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims and their equivalents.

What is claimed is:

1. A method of supporting a communication-based service by a user terminal using an intelligent inference engine, the method comprising:
activating a specific terminal function of the user terminal;
automatically processing information generated according to the activation of the terminal function using the intelligent inference engine; and
outputting information processed by the intelligent inference engine.

2. The method of claim 1, wherein automatically processing the information comprises at least one of:
outputting the processed information to the user terminal; and
transmitting the processed information to a connection terminal related with the activation of the specific terminal function of the user terminal.

3. The method of claim 1, wherein activating the specific terminal function comprises at least one of:
forming a communication channel with an external specific connection terminal, and activating the specific terminal function based on the communication channel;
collecting the current location information of the user terminal;
collecting circumference information related with the current location information based on at least one of already stored information and information provided by the external specific connection terminal; and
providing the collected information.

4. The method of claim 3, further comprising transmitting data in a Peer-to-Peer (P2P) communication scheme between the connection terminal and the user terminal.

5. The method of claim 3, wherein automatically processing the information comprises:
receiving a call connection request from the connection terminal;
determining a current location of the user terminal;
collecting response information to be provided to the connection terminal in response to the current location; and
providing the response information to the connection terminal.

6. The method of claim 3, wherein automatically processing the information comprises:
receiving text information from the connection terminal;
extracting meaningful words from the received text information; and
automatically updating a user database with the extracted words.

7. The method of claim 3, wherein automatically processing the information comprises:
collecting current location information of the user terminal;
searching for circumference information based on the collected location information; and
searching for and providing additional circumference information or detailed circumference information according to movement of the user terminal.

8. The method of claim 3, wherein automatically processing the information comprises:
receiving text information or a voice signal from the connection terminal;
extracting meaningful words from at least one of the text information and the voice signal;
searching for information related with the extracted words from at least one of a memory of the user terminal and an external specific connection terminal; and
recommending the searched information.

9. The method of claim 3, wherein automatically processing the information comprises:
providing, by the user terminal, negotiation criteria information to the connection terminal;
receiving negotiation response information corresponding to the criteria information from the at least one connection terminal;
generating negotiation determination information based on the negotiation response information; and
providing the generated negotiation determination information to the connection terminal.

10. The method of claim 3, wherein automatically processing the information comprises:
providing, by the user terminal, negotiation criteria information to a plurality of connection terminals;
receiving negotiation response information from the plurality of connection terminals;
extracting common range information from the negotiation response information;
providing the common range information to the plurality of connection terminals;
receiving preference response information that discloses preference information within the common range information from the plurality of connection terminals; and
generating the negotiation determination information based on the preference response information.

11. The method of claim 10, wherein, when receiving the negotiation response information, the connection terminal automatically extracts empty schedule information within the negotiation criteria information based on already stored information and terminal use record information of a user, and writes and transmits the negotiation response information.

12. The method of claim 10, wherein, when receiving the preference response information, the connection terminal automatically selects a certain date as a preference date within a common range, based on at least one of a user's terminal use record information, features of each date, and previous user-related information, and writes and transmits the preference response information.

13. A user terminal including an intelligent inference engine, the user terminal comprising:
a display that outputs a screen according to an activation of a terminal function;
a communication unit that forms a communication channel with at least one connection terminal according to the activation of the terminal function;
a memory that stores a Machine Intelligent Agent (MIA) module including the intelligent inference engine, a user database, and a recognition database for supporting a recognition function;
an information collection unit that collects location information; and
a controller that processes and transmits information for supporting the terminal function using the intelligent inference engine.

14. The user terminal of claim 13, wherein the communication unit transmits data in a Peer-to-Peer (P2P) communication scheme.

15. The user terminal of claim 13, wherein the controller extracts meaningful words from received text information and
wherein the display outputs a pop-up window for confirming determination of an automatic update of a user database based on the extracted words.

16. The user terminal of claim 13, wherein the display displays one of:
a circumference information search screen, based on current location information; and
a screen that provides additionally searched circumference information or detailed circumference information according to movement of the user terminal.

17. The user terminal of claim 13, wherein the display displays a screen displaying information related with meaningful words recognized in at least one of text information and a voice signal transmitted or received.

18. The user terminal of claim 13, wherein the display displays at least one of:
a screen for setting negotiation criteria information to be provided to at least one connection terminal;
a screen for displaying negotiation response information received from each connection terminal;
a screen for displaying common range information commonly included in the negotiation response information;
a screen for displaying, by the connection terminals, preference response information reflecting preference information among the common range information; and
a screen for displaying negotiation determination information determined from the preference response information or the negotiation response information.
